(19) United States
(12) Patent Application Publication
(10) Pub. No.: US 2017/0239683 A1
(43) Pub. Date: Aug. 24, 2017

(54) APPLICATION DEVICE FOR MATERIALS

(71) Applicant: SIKA TECHNOLOGY AG, Baar (CH)

(72) Inventors: Christian SCHULTHEISS, Pfäffikon (CH); Pascal TANNER, Schmerikon (CH)

(73) Assignee: SIKA TECHNOLOGY AG, Baar (CH)

(21) Appl. No.: 15/513,418

(22) PCT Filed: Sep. 18, 2015
(86) PCT No.: PCT/EP2015/071506

§ 371 Date: Mar. 22, 2017

(30) Foreign Application Priority Data
Sep. 23, 2014 (EP) 14186037.9

(51) Int. Cl. B05C 17/005; B05C 17/01; B01F 15/02; B01F 13/00; B01F 7/00; B01F 15/00

(52) U.S. Cl. CPC B05C 17/00566; B01F 7/00141; B01F 7/00216; B01F 7/00725; B01F 15/00538; B01F 15/0087; B01F 15/0218; B01F 15/0237; B01F 13/0027; B01F 7/0025; B05C 17/0103; B05C 17/0133; B05C 17/00576; B05C 17/00596; B01F 2215/0039; B01F 2215/006; B01F 2015/00655

(57) ABSTRACT

An application device for materials, in particular adhesives, including at least one cartridge receiving device for receiving a replaceable cartridge which contains a material and has a material outlet opening; a rotary device for metering or mixing the material, rotary device having a first engagement element; a drive device for driving the rotary device, the drive device having a rod which is mounted in a rotatable and axially movable manner and has a second engagement element at the end face; and a gearing unit for driving the rod in order to bring the first and the second engagement element into engagement with each other.

### TECHNICAL SCOPE

The invention relates to an application device for materials, in particular adhesives, according to the preamble of claim 1.

### PRIOR ART

EP 2 468 415 A1 discloses an application device for multi-component materials, where, with the assistance of an expelling device, material components are pressed out of two cartridges at the same time, mixed in a rotary mixer and are applied by means of a discharging tip. For this purpose, the expelling device here includes an electric motor which, by means of a gearing unit, drives a drive axis, by way of which the rotary mixer is driven, and a rotary axis, by way of which a rotary piston is screwed into a first cartridge. In this case, the rotary piston or rather the rotary mixer has to be connected to the rotary axis or rather the drive axis, for example when the application device has been disassembled for the purposes of using new or re-filled cartridges.

To connect the rotary piston to the rotary axis, it is proposed to realize the rotary piston with an internal hexagon and the rotary axis with an external hexagon. In order to address the problem of positioning the rotary axis and the rotary piston during assembly, among other things a connection variant is proposed where form-fitting torque transmission is brought about with a guiding mandrel for the radial positioning and ramp-like latching shoulders for positioning in the circumferential direction.

The disadvantage of designing the connection in such a manner is that it is necessary to adapt both connection parts, that is to say the rotary axis and the rotary piston. The production of the proposed connection geometry is additionally time-consuming and expensive, in particular when the connection parts are produced from metal. In addition, when both connection parts contact one another in an unfavorable manner, up to half a revolution and a relatively large axial displacement are necessary until the connection parts reach their form-locking position. It is not possible to compensate for axial relative movements between the rotary axis and the rotary piston. The prior art deviates from secure torque transmission via proven polygonal profiles in favor of less sturdy, less reliable and more expensive connection geometry.

EP 2 606 986 A1 also shows an application device for multi-component materials and proposes realizing the expelling rod as a polygonal element, Torx element or jaw element. Realizing the expelling rod in a “self-finding” manner corresponding to an engagement device on the expelling rotary piston is additionally proposed here. However, no specific embodiments are indicated as to how an expelling rotary piston can be correspondingly designed.

EP 2 606 984 A1 describes the problem where non-correct engagement between the expelling rod and the expelling piston can result in failure, as a result of which defective gluing spots can occur. Using a braking element, which is entrained with the expelling rod, as a position marker in order to recognize such a failure is proposed.

Consequently, the problem exists in the prior art that when a rotary device of a named application device is connected to a drive rod, the connection parts can cant or become damaged, above all when, in this case, engagement elements produced from softer and harder materials contact one another. In addition, as a result of engaging the connection parts in a wrong manner, the materials can be pressed out in an uncontrolled manner or intermixed in an irregular manner. As a result of unwanted deviation from the desired metering of the material or rather from the desired mixing conditions of multi-component materials in the application device, it is impossible to guarantee constant processing quality.

The object underlying the invention, consequently, is to provide an application device where correct and secure engagement between a drive rod and a rotary device is ensured, in particular in the case of different material pairings. In addition, the production of a corresponding drive rod and a rotary device is to be simple and cost-efficient so that they are also able to be produced economically as disposable parts.

### DISCLOSURE OF THE INVENTION

Said object is achieved by an application device with the features of claim 1. Advantageous further developments are provided in the subclaims.

In particular, the object is achieved by an application device for materials, in particular adhesives, which includes the following:
at least one cartridge receiving device for receiving a replaceable cartridge which contains a material and comprises a material outlet opening,
a rotary device for metering or mixing the material, wherein the rotary device comprises a first engagement element,
a drive device for driving the rotary device, wherein the drive device includes a rod, which is mounted so as to be rotatable and axially displaceable and comprises a second engagement element at the end face, and a gearing unit for the connection of an, in particular electric, drive, wherein the gearing unit drives the rod in order to move the first and the second engagement elements into engagement with one another,
   wherein the first and the second engagement elements comprise polygonal profiles which are adapted to one another and have engagement aids, by means of which engagement aids the polygonal profiles, in particular in the circumferential direction of the polygonal profiles, are aligned with respect to one another.

An essential core concept of the present invention consists, in this case, in designing the first and second engagement elements in such a manner that they comprise polygonal profiles which are adapted to one another and have engagement aids, the polygonal profiles being aligned with respect to one another as a result of the engagement aids. Only polygonal profiles which have been aligned with respect to one another allow correct engagement of the engagement elements with or rather in one another and secure and defined transmission of torque. Where polygonal profiles have not been aligned correctly, they can either not engage with one another at all or the engagement elements can be canted or damaged, in particular as a result of slipping.

Engagement elements can be correspondingly designed ends or end faces of a shaft, rod or of a piston and can provide, in particular, indentations or elevations. A polygonal profile can be understood, in particular, as a polygonal, preferably regular or symmetrical cross section. A polygonal profile can be realized as a cross section of a polygon, for example as an external profile of a rod or a shaft, and of a corresponding polygonal opening or indentation, for example as an internal profile of a piston or of a shaft. Alignment with respect to one another can be understood in the case of polygonal profiles as the edges or corners of two oppositely situated profiles matching spatially or rather coinciding, in particular such that they are congruent. In particular, this can be achieved as a result of an identical orientation of two polygonal profiles in the circumferential direction of the polygonal profiles. The circumferential direction of a polygonal profile can be understood as the circumferential direction of a circle in which the polygonal profile can be inscribed.

An engagement aid can be understood as any device which facilitates, promotes or makes possible in the first place, engagement between the first and second engagement elements. An engagement aid could be based on various physical operating principles, for example a magnetic field, and could exercise its auxiliary function either independently or in a controlled manner. Engagement aids are preferably realized as specific geometric designs of the first and/or second engagement elements. In this case, the polygonal profile can itself be adapted in a suitable manner, or additional auxiliary devices can be provided on the engagement elements which facilitate engagement on polygonal profiles which are known per se.

The engagement aid can comprise, in particular, one or several recesses and/or projections. The one or several recesses can be tapered (in particular when the one or several recesses is/are provided on the rotary device) or widened (in particular when the one or several recesses is/are arranged on the rod) in the direction of an end of the rotary device remote from the rod.

Correspondingly, one or several projections can be widened (in particular when the one or several recesses is/are provided on the rotary device) or tapered (in particular when the one or several recesses is/are arranged on the rod) in the direction of an end of the rotary device remote from the rod.

In a preferred embodiment, the engagement aids can comprise a triangular cross section (and when considered spatially) can be designed as a tetrahedron volume. A (plain) inside bevel (on a hexagonal profile) without additional engagement aids, such as, for example, shown in FIG. 12 of EP 2 468 415 A1, is not an engagement aid according to the invention. In particular, the functional specifications of the present invention are not met with a (plain) inside bevel of this type. Insofar as bevels (inside bevels, for example on a hexagonal profile) are provided according to the invention, one or several engagement aids (as explained in detail above or below) are to be additionally provided. In a specific further development, therefore, an inside bevel is provided on the rotary device (for example on a polygonal, preferably hexagonal profile), at least one engagement aid being additionally provided.

The rotary device is realized, in particular, for mixing the material, therefore including a mixing device, for example a rotary mixer (mixing rotor) which can mix, where applicable, two-material or multi-material components. As an alternative to this or in addition to it, the rotary device can be a device for metering (in particular expelling) one or several material components. For example, therefore, the rotary device is an expelling rotary device, e.g. including an expelling rotary piston (or forming such an expelling rotary piston).

The advantage of such an application device is that the drive rod and the rotary device correctly and securely engage one another by means of aligning their engagement elements with respect to one another so that the rotary device is able to be driven in a reliable manner. Polygonal profiles are simple to produce and have proven their worth for reliably transmitting torque. In addition, polygonal profiles make it possible to create an axially displaceable, non-rotatable connection which compensates for the axial movements of the engaging elements.

In a further development of the invention, the first or rather second engagement element moves into contact with the engagement aids when the engagement elements move closer. Contact is made, in particular, as a result of an axial displacement of the rod, in particular when the engagement elements move into one another. In this respect, an engagement aid can also be understood as a run-in aid which has a guiding effect when contacting the engagement elements and promotes the sliding into one another of the engagement elements. The engagement aids can be designed such that when the engagement elements move closer, the polygonal profiles rotate toward one another until they are correctly aligned with respect to one another. The advantage of such a design is that the polygonal profiles are automatically aligned as soon as the drive rod and the rotary device are to be axially coupled, for example once the application device has been assembled and the axial feed of the rod actuated.

In a further development of the invention, the engagement aids comprise sliding surfaces which are aligned in each case in the direction of an edge of the polygonal profile, wherein, in particular, the surface normals of the sliding surfaces enclose acute angles with a circumferential direction of the polygonal profiles. A top surface of an engagement element can slide along a sliding surface on contact. As a result, for example, an outside edge of the polygonal profile of the rod can be steered in the desired direction of the inside edge of the polygonal profile of the rotary device. In the case of a known beveled polygonal profile with inside or outside bevels, the surface normals of the bevel surfaces are perpendicular to the circumferential direction of the polygonal profile. As a result of arranging the sliding surfaces at an acute angle, that is to say in an angled position, according to the invention with respect to the circumferential direction, a contact force can be generated in the circumferential direction which can be utilized for alignment.

In a further development of the invention, the engagement aids comprise pairs of first and second sliding surfaces which are arranged symmetrically with respect to one another in the circumferential direction of the polygonal profiles. As a result, the polygonal profiles can be aligned with respect to one another in both circumferential directions, that is to say in and against the direction of rotation of the rotary device or rather of the rod, depending on how the first and second engagement elements contact one another. Consequently, correct engagement is achieved as a result of rotating the engagement elements as little as possible with respect to one another.

In an alternative further development of the invention, the engagement aids comprise sliding surfaces, which are aligned in the circumferential direction of the polygonal profiles, preferably only in the direction of rotation of the rod, on only one side. As a result, alignment of the polygonal profiles with respect to one another is only possible in one circumferential direction, preferably only in the direction of rotation of the rod. Consequently, rotating the engagement elements with respect to one another in a fixed direction is guaranteed and, as a result, a correct engagement is achieved.

In a further development of the invention, an engagement aid is realized as a tetrahedron volume, which projects, preferably centrally, in particular with a corner of the tetrahedron out of an angled surface of an inside bevel of the polygonal profile. Such a design of the engagement elements is simple to produce and can be realized, in particular, in one operating step with the inside bevel or rather the polygonal profile. In dependence on the material, a punching, forging or preferably a casting process is conceivable, in particular for plastics materials.

In a further development of the invention, the polygonal profiles are hexagonal profiles which are preferably beveled. The first engagement element, in particular the rotary device, preferably comprises an internal hexagonal profile and the second engagement element, in particular the rod, preferably comprises an external hexagonal profile. Other polygonal profiles, for example, triangular, square or octagonal profiles or profiles with polygons with even more corners, are also conceivable. A hexagon is a proven profile which is simple to produce, enables relatively simple engagement as a result of rotation by no more than 60° in one direction and at the same time is able to transmit a high torque.

In a further development of the invention, the first and the second engagement elements are produced from different materials, in particular from plastics material and steel. In this case, the first engagement element is preferably produced from plastics material and engagement aids are preferably only provided on the first engagement element. As a result, a cost-efficient production for different material pairings is possible. In particular, it is possible to dispense with providing engagement aids on the second engagement element, which is preferably produced from steel. In this way, a first engagement element could be designed as a disposable part and produced in a cost-efficient manner. In particular, the first engagement element is realized in one piece with the rotary device. As a result, the entire rotary device, in particular an expelling rotary piston, could be realized as a disposable part and be disposed of, for example, together with an empty cartridge.

In a further development of the invention, a braking element is provided for braking the rotational movement of the rod, which braking element generates an axial feed movement of the rod even with the rod idling. The braking element can be realized, for example, as a wrap spring housing or a plastics material brake. The braking element is preferably realized so as to be entrained axially with the rod. When idling, that is to say when the first and the second engagement elements are not engaged and no torque is transmitted, a gearing unit, by means of which the rod is driven, in particular by a threaded drive, could under certain circumstances not effect an axial feed of the rod. An axial movement can be generated from a rotary movement of the rod as a result of a braking element which exerts a relatively low braking torque on the rod. As a result, the rod is moved with the second engagement element in the direction of the first engagement. As soon as the engagement elements move into engagement, the feed is then easily able to be generated as a result of a transmission of torque.

According to the invention, in said further development the braking element can be freely movable in the circumferential direction of the rod within an angular range which is adapted to the polygonal profile, preferably such that a further feed movement is not generated until the polygonal profiles are aligned with respect to one another. As a result, the rod can carry out the rotational movement, which is necessary in order to align the polygonal profiles with respect to one another, in a (substantially) free manner. For example, the braking element could be mounted in a groove so as to be displaceable in the circumferential direction. As a result, it would not be able to develop its braking action, or only develop it in a restricted manner whilst it is rotated over a certain angular range. The operations for alignment and engagement of the engagement elements are further facilitated in this manner.

In particular, the polygonal profiles can be hexagonal profiles and the axially entrained braking element can be mounted so as to be freely movable over a circumferential angular range of the rod of approximately 60°. The maximum necessary rotation of the rod is consequently adapted to the geometry of the polygonal profile such that engagement is able to be effected in a particularly easy manner.

In a further development of the invention, the rotary device is an expelling rotary piston with an external thread. In this case, the drive device screws the expelling rotary piston into the cartridge in order to expel the material out of the cartridge through the material outlet opening. The rod can comprise a threaded spindle portion, and be designed in portions as a round shaft or with a different cross section. The expelling rotary piston can be a cylindrical body which rotates along the inside wall of a cylindrical cartridge. The cartridge does not have to comprise an internal thread. The external thread can be realized in a self-tapping manner. The material can be, in particular, an accelerator component of an adhesive.

In particular, engagement aids can be provided only on the expelling rotary piston, wherein the expelling rotary piston is replaced together with the cartridge, preferably as a disposable part produced from plastics material. As a result, engagement aids can be realized in a cost-efficient manner with the polygonal profile of the expelling rotary piston, which can serve, at the same time, as a closure of the cartridge and is disposed of with the empty cartridge.

In an alternative further development of the invention, the rotary device is a mixing rotor which mixes expelled materials, in particular material components.

In this case, the mixing rotor comprises a rotor shaft and a mixing mandrel, around which several mixing blades are arranged, wherein the rotor shaft comprises the first engagement element. The mixing rotor can be a component of a dynamic mixer. The mixing rotor can be realized in one piece, in particular of plastics material. In this way, the mixing rotor could be designed as a disposable part, in particular as part of a disposable mixer, and produced in a cost-efficient manner. The rod can comprise a threaded spindle portion, and be designed in portions as a round shaft or with a different cross section. As a result of designing the mixing rotor according to the invention, secure and correct engagement of the rod in the mixing rotor is facilitated. As a result, a reliable and uniform stirring movement of one material or an intermixing of several material components can also be ensured.

In a further development of the invention, the application device according to the invention is suitable for applying multi-component materials, in particular multi-component adhesives or multi-component sealing compounds. In this case, several replaceable cartridges are provided with individual material components and the drive device is designed for simultaneously expelling the material components out of the cartridges through material component outlet openings by means of expelling pistons which move into the cartridge receiving device or rather the cartridges. The rotary device, in this case, can be an expelling rotary piston or a mixing rotor. In a preferred embodiment, two rotary devices are provided, one of which is an expelling rotary piston and one is a mixing rotor. In this case, it would also be possible to provide two rods which, in each case, drive the expelling piston and the mixing rotor. The expelling rotary piston, in this case, can press an accelerator out of the cartridge, whilst a second cartridge can be provided as a tubular bag, out of which a second expelling piston, not necessarily as a result of screwing into the cartridge, presses out a second adhesive component. As a result of the simultaneous expulsion, a certain mixing ratio of both components is achieved. The mixing rotor intermixes the two material components in a uniform manner such that a high processing quality of the multi-component mixture is achieved.

### REPRESENTATION OF THE INVENTION

The invention is also explained below in more detail with regard to further features and advantages by way of the description of exemplary embodiments and with reference to the drawings below, in which :

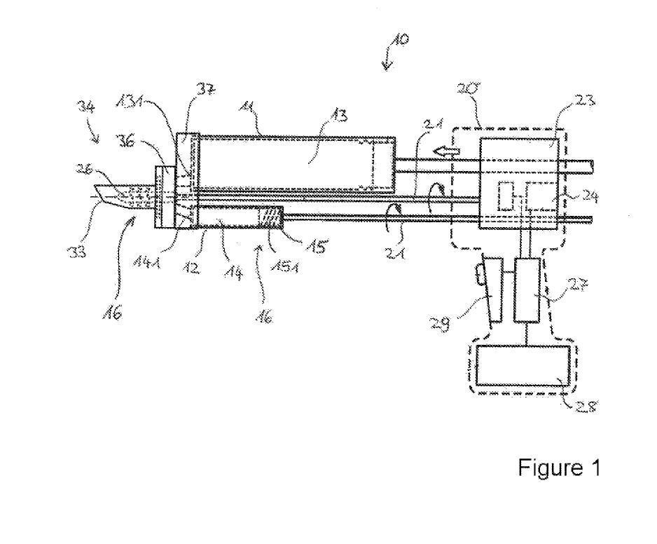

FIG. 1 shows a schematic design of an embodiment of the application device according to the invention;

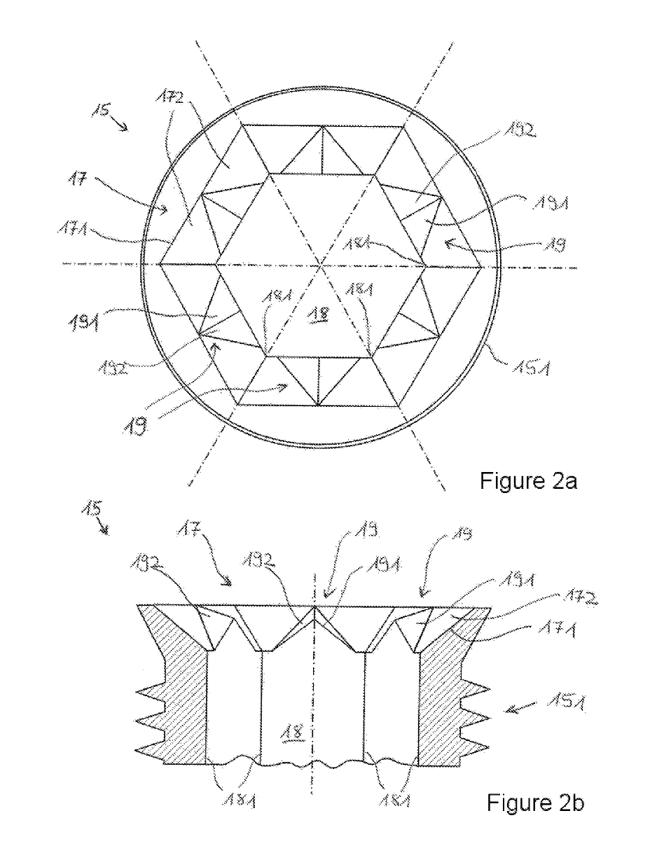

FIG. 2a shows a top view of an embodiment of an expelling rotary piston according to the invention;

FIG. 2b shows a side sectional representation of an embodiment of an expelling rotary piston according to the invention according to FIG. 2a;

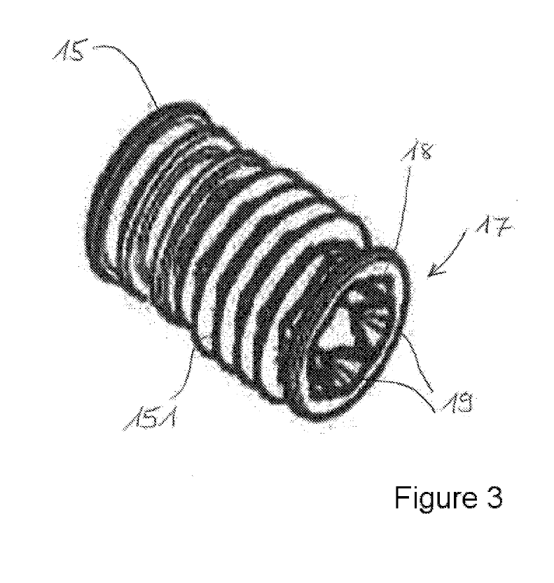

FIG. 3 shows a perspective view of an embodiment of an expelling rotary piston according to the invention;

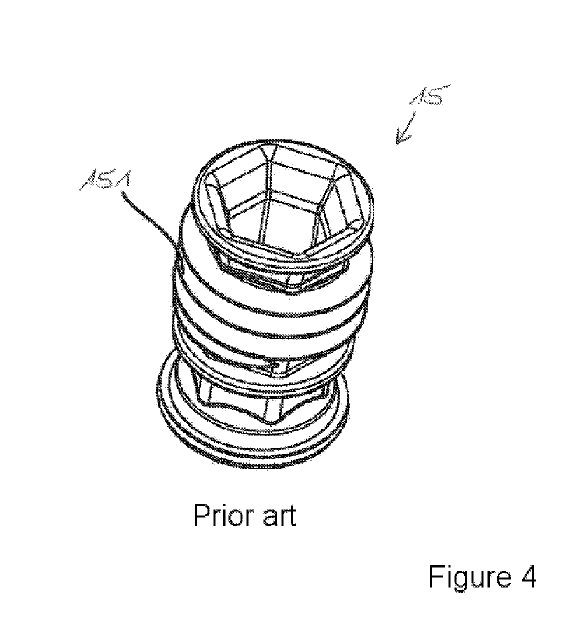

FIG. 4 shows an expelling rotary piston according to the prior art;

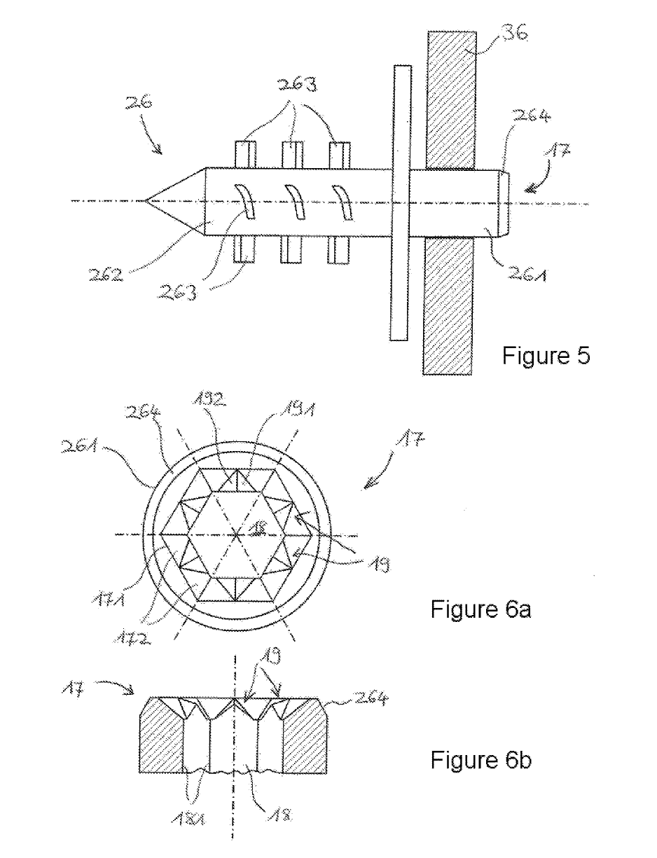

FIG. 5 shows an embodiment of a mixing rotor according to the invention;

FIG. 6a shows a top view of an embodiment of a mixing rotor according to the invention;

FIG. 6b shows a side sectional representation of an embodiment of a mixing rotor according to the invention according to FIG. 5a;

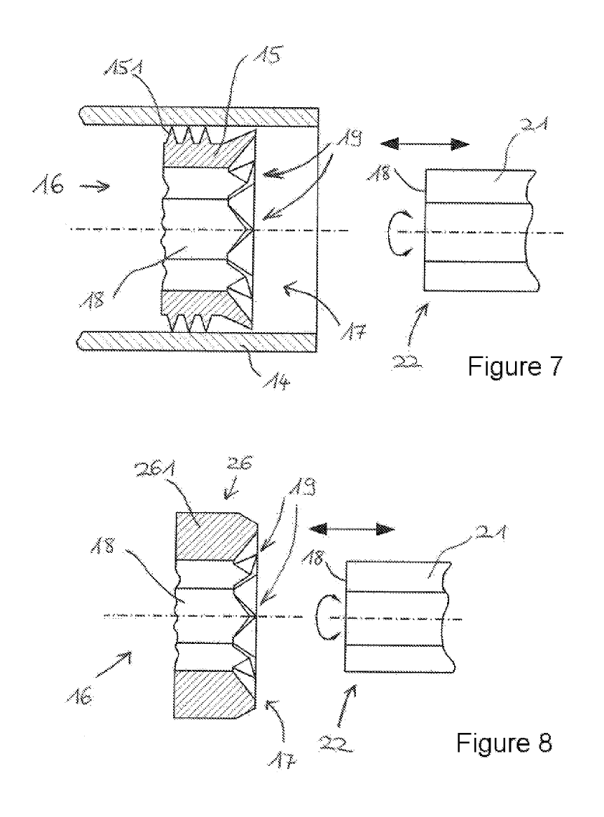

FIG. 7 shows a side view of an embodiment of an expelling piston according to the invention and of a rod;

FIG. 8 shows a side sectional representation of an embodiment of a mixing rotor according to the invention and of a rod;

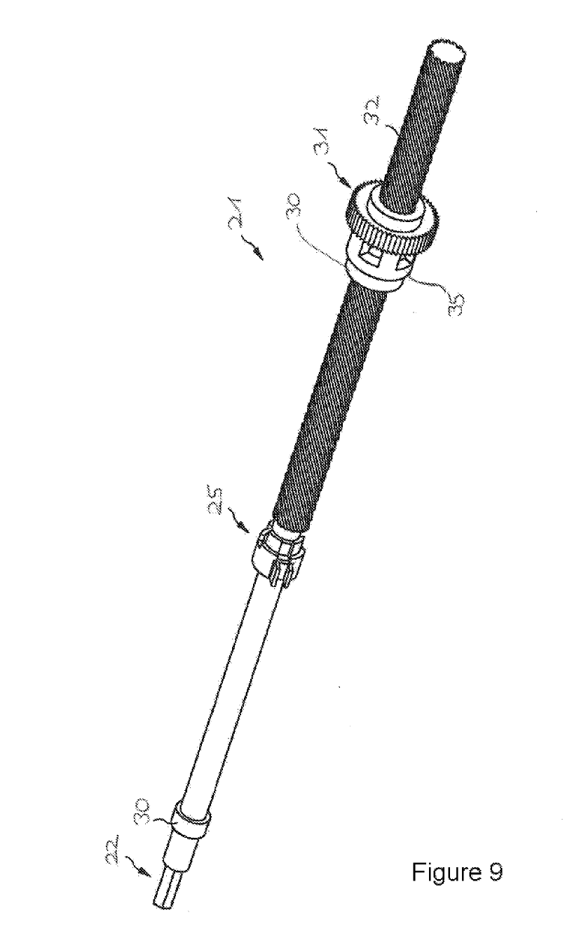

FIG. 9 shows a perspective view of an embodiment of a rod according to the invention;

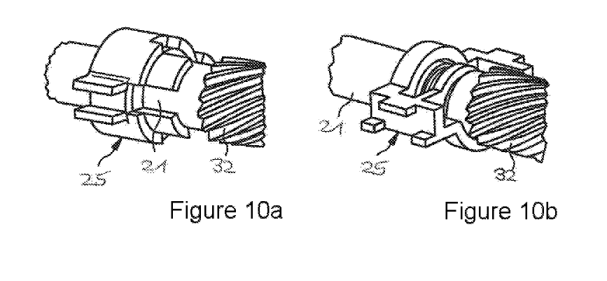

FIG. 10a shows a perspective view of an embodiment of a braking element as a wrap spring housing;

FIG. 10b shows a perspective view of an embodiment of a braking element as a plastics material brake.

The same reference symbols are used for identical and identically operating elements in the following part of the description of the invention.

FIG. 1 shows a schematic representation of an application device 10 for materials, in particular multi-component materials, further particularly multi-component adhesives or multi-component sealing compounds. The application device 10 comprises two cartridge receiving devices 11 and 12, one for a cartridge 13 with a material outlet opening 131 and one for a cartridge 14 with a material outlet opening 141. The cartridge 13 is preferably realized as a tubular bag and contains a first material component, whilst the cartridge 14 is realized as a rigid (self-supporting) cartridge and contains a second material component, preferably a booster or an accelerator. An expelling rotary piston 15 with the external thread 151 is screwed by the rod 21 (the lower of the two rods 21 in the drawing) into the cartridge 14 in order to press out the first material component. An expelling piston 132 presses the second material component out of the cartridge 13. The material components are mixed in a mixer 34 and expelled through a discharging tip 33. The rod 21 (the upper of the two rods 21 in the drawing) drives the mixing rotor 26 in a rotating manner. The expelling rotary piston 15 and the mixing rotor 26 each provide an embodiment of a rotary device 16 according to the invention. The two rods 21 can be realized exclusively variously or identically. They are mounted so as to be rotatable and axially displaceable. In particular, they can be driven variously, preferably separately from one another. The mixer rotor 26 is rotatably mounted in the mixer attachment 36 which is fitted onto the cartridge cap 37, by means of which the expelled material components are pressed into the mixer 34. The drive device 20 includes a gearing unit 23 and a preferably electromotive drive 24, which can be controlled by a drive control unit 27, being supplied with, in particular, electric power via a battery 28 and can be actuated by means of a control unit 29. Reference is made to EP 2 606 984 A1 with regard to possible designs and to the method of operation of the drive device.

FIGS. 2a and 2b show an expelling rotary piston 15 according to the invention which comprises a first engagement element 17 with a polygonal profile 18 which is realized here as a hexagonal profile. On an end-face inside bevel 171 of the expelling rotary piston 15, a total of six regularly arranged engagement aids 19 are arranged on the six bevel surfaces 172 which project, in each case centrally, in the form of tetrahedron volumes from a bevel surface 172 of the inside bevel 171. The engagement aids 19 are designed symmetrically and comprise in each case first 191 and second 192 triangular sliding surfaces, which provide the side surfaces of the tetrahedron volumes. A side surface of a tetrahedron volume connects in each case to an inside surface of the internal hexagon, said side surface not necessarily having to be in the same plane, but could also be tipped outward against the inside surface of the internal hexagon. The height of the engagement aids 19 or rather the depth of the inside bevel 171 is shown here to be smaller than the diameter of the polygonal profile 18, but could also be approximately the same size or larger. The width of the engagement aids 19 could extend directly up to the edges of the polygonal profile 18, or could be realized in a narrower manner. The side edges of the tetrahedron volumes do not have to be straight, but can also be curved. Other curve progressions, which can be optimized, in particular, with reference to optimized engagement or rather to an external polygon running into the corresponding internal polygonal profile, are also conceivable. The engagement aids 19 do not have to be realized in a symmetrical manner but can also be designed on one side such that they only comprise in each case one single sliding surface. The surface normals of the sliding surfaces 191, 192 form an acute angle with the circumferential direction of the polygonal profile 18. Each edge 181 of the polygonal profile 18 does not necessarily have to have assigned thereto an engagement aid 19. It would also be possible to have fewer or more engagement elements 19 than edges 181. The first engagement element 17 with the polygonal profile 18 and the engagement aids 19 is shown here in a schematically simplified manner. It is possible, in particular, to provide curves usual for polygonal profiles and deviations from the geometries shown with sharp edges in the drawing which can be specified, for example, as a result of manufacturing tolerances, as casting radii or desired curves for improved engagement behavior.

FIG. 3 shows a perspective view of an expelling rotary piston 15 according to the invention, in the end face of which a polygonal profile 18 is realized with engagement aids 19 according to the invention.

In comparison to this, FIG. 4 shows an expelling rotary piston with an external thread according to the prior art which does not comprise any engagement aids according to the invention. An inside bevel is certainly realized on a hexagonal profile. In particular, here, the surface normals of the six bevel surfaces of the inside bevel are in each case perpendicular to the circumferential direction of the hexagonal profile. It has been shown, however, that a plain inside bevel without additional engagement aids, as are proposed in the present invention, is not able to solve satisfactorily the problem of incorrect engagement of an expelling rod in the expelling rotary piston shown. In particular, when the expelling rotary piston is produced from a softer material, for example plastics material, than the expelling rod, the expelling rotary piston can be canted or rather damaged such that it is not possible to screw the expelling rotary piston in a reliable and controlled manner into a cartridge. Reference is made to EP 2 468 415 A1 for further designs of an expelling rotary piston as is known from the prior art.

FIG. 5 shows a mixing rotor 26 which is rotatably mounted in the mixer attachment 36 and comprises a mixing mandrel 262 with a plurality of mixing blades 263 and a rotor shaft 261 with the outside bevel 264. When the mixing rotor 26 rotates, the mixing blades 263 promote the stirring of a material or the mixing of different material components which are supplied from the cartridges. The outside bevel 264 facilitates the inserting of the mixing rotor 26, which here is realized in one piece, into the mixer attachment 36. A first engagement element 17 is provided on the end face of the rotor shaft 261.

FIGS. 6a and 6b show the first engagement element 17 of the mixing rotor 26 according to the invention shown in FIG. 5 in more detail. In this respect, the statements made concerning FIGS. 2a and 2b are applicable with the exception of the mixing rotor 26 or rather the rotor shaft 261 not having an external thread in contrast to the expelling rotary piston 15.

FIGS. 7 and 8 illustrate the interaction between the first engagement element 17 and the second engagement element 22 which, in each case, comprise corresponding polygonal profiles 18. The rod 21 and the cartridge 14 or rather the rotor shaft 261 are movable axially relative to one another, for example in the application device 10 according to FIG. 1 the rods 21 being axially movable, whilst the cartridge 14 or rather the rotor shaft 261 being axially fixed. In this case, engagement aids 19 are only realized on one side, namely on the first engagement element 17, whilst the second engagement elements 22 comprise, in each case, a known hexagonal exterior profile without engagement aids. It would be conceivable, in principle, for only the second engagement elements 22 or the first 17 and the second 22 engagement elements to comprise engagement aids 19. When the rod 21 contacts the first engagement element 17 in a position in the circumferential direction such that neither of the two polygonal profiles 18 are congruent with one another, the rod 21, when the second engagement element 22, in particular its end face, approaches or rather contacts the engagement aids 19, is automatically rotated such that the edges 181 of the two polygonal profiles 18 coincide and the rod 21 is able to enter with its second engagement element 22 into the interior of the expelling rotary piston 15 or rather of the rotor shaft 261. FIGS. 7 and 8 consequently show first engagement elements 17 and second engagement elements 22 which are precisely not in engagement. Torque transmission is possible by means of the polygonal profiles 18 as soon as the exterior hexagon of the rod 21 is received in a positive locking manner in the interior of the expelling rotary piston 15 or rather of the rotor shaft 26. The axial relative movement and the rotatability of the two parts with respect to one another are indicated by the double arrows. The first engagement element 17, or in the case of an integral realization the entire expelling rotary piston 15 or rather the mixing rotor 26, is preferably produced from plastics material, whilst the second engagement element 22 or rather the rod 21 is preferably produced from steel.

However, it can also be produced from plastics material. As a result of realizing the engagement aids 19 exclusively on the side of the first engagement element 17, the steel part can be realized as a known polygonal profile, in particular as a hexagonal profile. The geometrically more complex first engagement element 17 can, in contrast, be produced in a cost-efficient and easy manner as a plastics material part. As a result, it is possible to design the expelling rotary piston 15 or rather the mixing rotor 26 as disposable parts and to dispose of them, for example, together with an empty cartridge 14 or rather a disposable mixer 34.

FIG. 9 shows an embodiment of a rod 21, which is mounted by means of bearings 30 so as to be rotatable and axially displaceable, in particular in a housing (not shown) of the application device 10. The rod 21 comprises, on an end, a threaded spindle portion 32 by means of which the rod 21 is able to be set in rotation and in axial movement by means of the threaded drive 31 with the threaded nut 35. The drive is effected, as described in conjunction with FIG. 1, by means of the gearing unit 23. The braking element 25 is realized here so as to entrain the rod 21, as described in detail in EP 2 606 984 A1. In contrast to the braking device shown there, however, in an embodiment according to the invention the braking element 25 can be freely movable in the circumferential direction of the rod 21 over a certain angular range, said angular range being adapted to the polygonal profile 18. Such mobility could be realized structurally, for example, by a guide in a groove, which, instead of or in addition to an axial guide, permits a degree of freedom of the movement element 25 in the circumferential direction of the rod 21. In the case of a hexagonal profile as a polygonal profile 18, such a circumferential angular range could be, for example, approximately 60°, but could also be smaller or larger. On one end of the rod 21, a second engagement element 22 is realized as a hexagonal shaft continuation which is preferably produced from steel.

FIGS. 10a and 10b show an embodiment of the movement element 25 as a wrap spring housing (FIG. 10a) and a plastics material brake (FIG. 10b), which can be realized such that they are mounted so as to be freely movable over a circumferential angular range, as described in conjunction with FIG. 9.

### LIST OF REFERENCES

10 Application device
11 Cartridge receiving device
12 Cartridge receiving device
13 Cartridge
131 Material outlet opening
132 Expelling piston
14 Cartridge
141 Material outlet opening
15 Expelling rotary piston
151 External thread
16 Rotary device
17 First engagement element
171 Inside bevel
18 Polygonal profile
181 Edge of the polygonal profile
19 Engagement aid
191 First sliding surface
192 Second sliding surface
20 Drive device
21 Rod
22 Second engagement element
23 Gearing unit
24 Drive
25 Braking element
26 Mixing rotor
261 Rotor shaft
262 Mixing mandrel
263 Mixing blade
264 Outside bevel
27 Drive control unit
28 Battery
29 Control unit
30 Bearing
31 Threaded drive
32 Threaded spindle portion
33 Discharge tip
34 Mixer
35 Threaded nut
36 Mixer attachment
37 Cartridge cap

1. An application device for materials, including adhesives, the application device comprising:
at least one cartridge receiving device for receiving a replaceable cartridge which contains a material, and having a material outlet opening;
a rotary device for metering or mixing material, wherein the rotary device includes a first engagement element;
a drive device for driving the rotary device, wherein the drive device includes:
a rod, which is mounted so as to be rotatable and axially displaceable, and which includes a second engagement element at an end face; and
a gearing unit for connection of an electric, drive, wherein the gearing unit is arranged to drive the rod in order to move the first and/or the second engagement elements into engagement with one another;
wherein the first and the second engagement elements include polygonal profiles which are adapted to one another and have engagement aids, by which engagement aids the polygonal profiles in a circumferential direction of the polygonal profiles, are aligned with respect to one another.

2. The application device as claimed in claim 1, wherein at least one of the first or second engagement elements moves into contact with the engagement aids when the engagement elements move closer as a result of an axial displacement of the rod when the engagement elements move into one another.

3. The application device as claimed in claim 2, wherein the engagement aids comprise:
sliding surfaces which are aligned in each case in a direction of an edge of the polygonal profile), wherein surface normals of the sliding surfaces enclose acute angles with a circumferential direction of the polygonal profiles.

4. The application device as claimed in claim 2, wherein the engagement aids comprise:
pairs of first and second sliding surfaces which are arranged symmetrically with respect to one another in the circumferential direction of the polygonal profiles.

5. The application device as claimed in claim 2, wherein the engagement aids comprise:
sliding surfaces, which are aligned in the circumferential direction of the polygonal profiles, only in a direction of rotation of the rod, on only one side.

6. The application device as claimed in claim 1, wherein an engagement aid is a tetrahedron volume, which projects centrally with a corner of the tetrahedron out of an angled surface of an inside bevel of the polygonal profile.

7. The application device as claimed in claim 1, wherein the polygonal profiles are beveled hexagonal profiles, wherein the first engagement element of the rotary device comprises:
an internal hexagonal profile and the second engagement element of the rod, comprises:
an external hexagonal profile.

8. The application device as claimed in claim 1, wherein the first and the second engagement elements are produced from among different materials which include plastics material and steel, the first engagement element being produced from plastics material and engagement aids being provided only on the first engagement element.

9. The application device as claimed claim 1, wherein the first engagement element one piece with the rotary device.

10. The application device as claimed in claim 1, comprising:
a braking element for braking rotational movement of the rod, via a wrap spring housing or a plastics material brake, which is configured to generate an axial feed movement of the rod even with the rod idling, wherein the braking element is entrained axially with the rod.

11. The application device as claimed in claim 10, wherein the braking element is freely movable in the circumferential direction of the rod within an angular range which is adapted to the polygonal profile, such that a further feed movement will not be generated until the polygonal profiles are aligned with respect to one another.

12. The application device as claimed in claim 10, wherein the polygonal profiles are hexagonal profiles and the axially entrained braking element is mounted so as to be freely movable over a circumferential angular range of the rod of approximately 60°.

13. The application device as claimed in claim 1, wherein the rotary device is an expelling rotary piston with an external thread, and the drive device is configured to screw the expelling rotary piston into the cartridge in order to drive material out of the cartridge through the material outlet opening.

14. The application device as claimed in claim 13, wherein engagement aids are provided only on the expelling rotary piston, wherein the expelling rotary piston is configured to be replaced together with the cartridge as a disposable part produced from plastics material.

15. The application device as claimed in claim 1, wherein the rotary device is a mixing rotor for mixing expelled materials, including material components, wherein the mixing rotor comprises:
a rotor shaft and a mixing mandrel around which several mixing blades are arranged, wherein the rotor shaft includes the first engagement element.

16. The application device as claimed in claim 1 for applying multi-component materials, including multi-component adhesives, the application device comprising:
several replaceable cartridges with individual material components, the drive device being configured for simultaneously expelling material components out of the cartridges through material component outlet openings with the aid of expelling pistons which are arranged to move into the cartridge receiving device or the cartridges.

17. The application device as claimed in claim 2, wherein the polygonal profiles are beveled hexagonal profiles, wherein the first engagement element of the rotary device comprises:
an internal hexagonal profile and the second engagement element of the rod, comprises:
an external hexagonal profile.

18. The application device as claimed in claim 17, comprising:
a braking element for braking rotational movement of the rod, via a wrap spring housing or a plastics material brake, which is configured to generate an axial feed movement of the rod even with the rod idling, wherein the braking element is entrained axially with the rod.

19. The application device as claimed in claim 18, wherein the polygonal profiles are hexagonal profiles and the axially entrained braking element is mounted so as to be freely movable over a circumferential angular range of the rod of approximately 60°.

20. The application device as claimed in claim 19, wherein the rotary device is an expelling rotary piston with an external thread, and the drive device is configured to screw the expelling rotary piston into the cartridge in order to drive material out of the cartridge through the material outlet opening.
